(19) United States
(12) Patent Application Publication
(10) Pub. No.: US 2026/0037871 A1
(43) Pub. Date: Feb. 5, 2026

(54) DATA AGGREGATION AND MODEL TRAINING BASED ON SPARSE DATASETS

(71) Applicant: Gontran Jerome de Quillacq, Fair Haven, NJ (US)

(72) Inventor: Gontran Jerome de Quillacq, Fair Haven, NJ (US)

(21) Appl. No.: 19/285,956

(22) Filed: Jul. 30, 2025

Related U.S. Application Data
(63) Continuation of application No. PCT/US2025/039685, filed on Jul. 29, 2025.
(60) Provisional application No. 63/677,679, filed on Jul. 31, 2024.

(51) Int. Cl. G06N 20/00; G06Q 20/40; G06Q 40/04

(52) U.S. Cl. CPC G06N 20/00; G06Q 20/4016; G06Q 40/054

(57) ABSTRACT

A system may access a set of training data and determine a timeframe associated with a positively labeled data item of the training data. A system may generate at least two new positively labeled data items based on the positively labeled data item to generate augmented training data. A system may train a machine learning model by applying the augmented training data as input to a machine learning model, and modifying a weight of the machine learning model.

### CROSS-REFERENCE TO RELATED APPLICATIONS

This application is a continuation of PCT/US2025/039685, filed Jul. 29, 2025, and titled “DATA AGGREGATION AND MODEL TRAINING BASED ON SPARSE DATASETS,” which claims priority to U.S. Provisional Patent Application No. 63/677,679, filed on Jul. 31, 2024, entitled “METHOD AND DEVICE FOR DETECTING COMPLEX FINANCIAL FRAUD,” the contents of which are hereby incorporated by reference in their entirety.

### BACKGROUND

Computing systems, or human reviewers, may review data associated with an investment fund, such as a hedge fund, to determine whether the data indicates that fraudulent activity may be, or has, occurred.

### SUMMARY

In some aspects, the techniques described herein relate to a method of training machine learning models including: accessing a set of training data including a subset of positively labeled data items and a subset of negatively labeled data items; augmenting the set of training data, where augmenting the set of training data includes: identifying a positively labeled data item of the subset of positively labeled data items; generating, based on the positively labeled data item, at least two new positively labeled data items, where each of the at least two new positively labeled data items is distinct from the subset of positively labeled data items; and combining the at least two positively labeled data items with the set of training data to generate augmented training data; applying the augmented training data as input to a machine learning model to cause the machine learning model to generate a training response; analyzing the training response to generate an analysis result; modifying a value of the machine learning model based on the analysis result to generate a trained machine learning model; and storing the trained machine learning model.

The method of the preceding paragraph can include any sub-combination of the following features: where generating, based on the positively labeled data item, a new positively labeled data item includes: determining a timeframe associated with the positively labeled data item; and dividing the positively labeled data into a plurality of new positively labeled data items, where each new positively labeled data item of the plurality of new positively labeled data items is associated with a portion of the timeframe, and where the at least two new positively labeled data items are of the plurality of new positively labeled data items; where the portion of the timeframe associated with each new positively labeled data item of the plurality of new positively labeled data items is non-overlapping; where the at least two new positively labeled data items replace the positively labeled data item in the set of training data; accessing first data from a first data source; accessing second data from a second data source; determining an association between the first data and the second data; and based on the association between the first data and the second data, generating the positively labeled data item; where determining the association between the first data and the second data includes: identifying a first entity identifier from the first data; identifying a second entity identifier from the second data; determining the first entity identifier is associated with the second entity identifier; and generating a link between the first data and the second data based on the first entity identifier being associated with the second entity identifier; where the first entity identifier is different from the second entity identifier; accessing additional data; applying a first data item of the additional data as input to the trained machine learning model to cause the model to generate an output; and determining, based on the output, the first data item is associated with potential fraudulent activity; where the output includes a probability score associated with the first data item, and where determining the first data item is associated with fraudulent activity is based on the probability score exceeding a threshold value; where the output includes a description of fraud indicators associated with the first data item; where augmenting the set of training data further includes: accessing a set of known fund investment strategies; identifying a negatively labeled data item of the subset of negatively labeled data items; comparing at least one of the negatively labeled data item or a data item associated with the negatively labeled data item to the set of known fund investment strategies to generate a comparison result, where the comparison result indicates an anomaly is present in the negatively labeled data item; based on the comparison result, relabeling the negatively labeled data item to generate an additional positively labeled data item; accessing first data from a first data source; accessing second data from a second data source; identifying a first entity identifier from the first data, where the first entity identifier is associated with a portion of the first data; identifying a second entity identifier from the second data, where the second entity identifier is associated with a portion of the second data, and where the second entity identifier is different from the first entity identifier; determining a first data item in the first data and a second data item in the second data is the same; based on the first data item and the second data item being the same, determining the first entity identifier and the second entity identifier are associated with a same entity; generating a link between the first entity identifier, the second entity identifier, and the same entity; based on the link, aggregating the portion of the first data and the portion of the second data to generate aggregated data; storing the aggregated data; applying the aggregated data as input to the trained machine learning model to cause the trained machine learning model to generate an output including a fraud probability score; determining, based on the fraud probability score, that at least one data item of the aggregated data is associated with potential fraud; and generating a report including an indication of the at least one data item; transmitting the report to a post-analysis review system; where the report further includes a description indicating a reason the at least one data item is associated with potential fraud; where the reason is generated by the trained machine learning model, and where the output includes the reason.

In some aspects, the techniques described herein relate to a non-transitory, computer-readable medium encoded with computer-executable instructions executable by a processor of a computing device, where the computer-executable instructions, when executed by the processor, cause the computing device to: access a set of training data including a subset of positively labeled data items and a subset of negatively labeled data items; augment the set of training data, where augmenting the set of training data includes: identify a positively labeled data item of the subset of positively labeled data items; generate, based on the positively labeled data item, at least two new positively labeled data items, where each of the at least two new positively labeled data items is distinct from the subset of positively labeled data items; and combine at least one of the at least two positively labeled data items with the set of training data to generate augmented training data; apply the augmented training data as input to a machine learning model to cause the machine learning model to generate a training response; analyzing the training response to generate an analysis result; modify a value of the machine learning model based on the analysis result to generate a trained machine learning model; and store the trained machine learning model.

The non-transitory, computer-readable medium of the preceding paragraph can include any sub-combination of the following features: where the computer-executable instructions, when executed by the processor, further cause the computing device to: access additional data; apply a first data item of the additional data as input to the trained machine learning model to cause the model to generate an output; and determine, based on the output, the first data item is associated with potential fraudulent activity; where the computer-executable instructions, when executed by the processor, further cause the computing device to: replace the positively labeled data item in the set of training data with the at least two new positively labeled data items; access first data from a first data source; access second data from a second data source; determine an association between the first data and the second data; and based on the association between the first data and the second data, generate the positively labeled data item.

In some aspects, the techniques described herein relate to a system including: a non-transitory computer-readable memory storing computer-executable instructions; and one or more processors in communication with the memory, where the computer-executable instructions, when executed by the one or more processors, causes the one or more processors to at least: access a set of training data including a subset of positively labeled data items and a subset of negatively labeled data items; augment the set of training data, where augmenting the set of training data includes: identify a positively labeled data item of the subset of positively labeled data items; generate, based on the positively labeled data item, at least two new augmented data items, where each of the at least two new augmented data items is distinct from the subset of positively labeled data items; and combine the at least two augmented data items with the set of training data to generate augmented training data; apply the augmented training data as input to a machine learning model to cause the machine learning model to generate a training response; analyzing the training response to generate an analysis result; modify a value associated with the machine learning model based on the analysis result to generate a trained machine learning model; and store the trained machine learning model.

### BRIEF DESCRIPTION OF THE DRAWINGS

Embodiments of various inventive features will now be described with reference to the following drawings. Throughout the drawings, reference numbers may be re-used to indicate correspondence between referenced elements. The drawings are provided to illustrate example embodiments described herein and are not intended to limit the scope of the disclosure. To easily identify the discussion of any particular element or act, the most significant digit(s) in a reference number typically refers to the figure number in which that element is first introduced.

FIG. 1 is a block diagram of an illustrative environment for identifying fraud indicators according to some embodiments.

FIG. 2 is a flow diagram of an illustrative routine for aggregating data from different data sources according to some embodiments.

FIG. 3 is a flow diagram of an illustrative routine for training a fraud detection model according to some embodiments.

FIG. 4 is a flow diagram of an illustrative routine for identifying potential fraud using a machine learning model according to some embodiments.

FIG. 5 is a block diagram of an illustrative computing system configured to identify potential fraud according to some embodiments.

### DETAILED DESCRIPTION

The present disclosure relates to the training and execution of a machine learning model to analyze hedge fund data and determine a likelihood of fraudulent activity occurring.

Some conventional systems allow for a human reviewer to indicate that a hedge fund may be engaging in fraudulent activity. A fund, as used herein, may refer to any type of pooled investment vehicle into which individuals or organizations may invest capital to obtain a return, usually by investing into complex strategies, such as leverage, short-selling or derivatives. Unlike Act '40 funds, hedge funds are restricted to accredited or institutional investors. They are opaque, as portfolio managers do not have to disclose their portfolio or their strategies. Hedge funds may or may not be registered with a regulator and may have various legal structures, often complex or made up of several legal entities and share classes. They may be US-based, global, or incorporated into a flexible offshore jurisdiction like the British Virgin Islands (BVI). Hedge funds have a wide diversity of strategies. For the purpose of the present disclosure, hedge funds also include ‘Alternative Strategies’, Separately Managed Accounts (SMAs), Fund-of-Hedge-Funds, or the strategies that a typical hedge fund portfolio manager manages, whatever the nature of his vehicle(s). Detection of fraud by a fund serves several important purposes. For example, many investors may not have a sufficient level of financial understanding to engage in individual investing and may rely on a fund to manage a significant amount of the investor's financial resources. In such examples, individual investors may face significant negative repercussions if a fund engages in fraud, up to and including a complete loss of the investor's principal and any intervening unrealized gains. A similar example may be applied to institutional investors, though the scale of the investment may differ significantly and fraud by a fund may affect many individuals associated with the institutional investor.

However, the detection of fraudulent activity by a fund presents a significant challenge to existing systems. For example, identifying fraudulent activity may be challenging due to the opaque nature of hedge fund operations, the scarcity of labeled data, and the intricate nature of financial fraud schemes where a fraudulent actor may be aware of methods of detecting fraud and take actions to obfuscate the fraudulent activity (e.g., by hiding fraudulent activity within data associated with non-fraudulent activity). Further, unlike other financial domains that may be affected by fraud (e.g., credit card fraud detection), where large volumes of well-labeled transactional data enable straightforward generation and application of automated detection systems, hedge fund fraud detection suffers from limited data availability, noisy and inconsistent reporting, and a lack of explicit fraud indicators (e.g., due to the low number of identified fraudulent events). Due to insufficient funding and the savviness of fraudsters, regulators and investors alike have difficulty detecting fraud. Robert Madoff, for instance, managed a massive Ponzi scheme for 21 years in broad daylight, while escaping all regulatory and private due diligence investigations. Further, different types of fraud exist, and each type of fraud may be associated with different fraud indicators exacerbating the issues caused by a lack of data associated with positively identified fraudulent activity. For example, fraud may occur when a manager delays, but still reports, loses or profits to curry better return statistics (smoothing), or favors one group of investors at the expense of another (cherry-picking), or conducts ‘honest’ trading strategies, like trading bitcoin or taking leverage, but which are not what was advertised to investors (misrepresentations). Additionally, actors engaged in financial fraud related to a fund are generally aware of previous fraudulent activity and the reasons the fraudulent activity was detected, allowing the actor to modify their behavior to avoid detection.

Accordingly, many conventional systems make use of significant amounts of manual review, relying on interviews, questionnaires and the experience of a human reviewer to identify signs of fraudulent activity. However, such systems may not have a consistent set of indicators of fraudulent activity and therefore may not be able to provide an indication of fraudulent activity with a sufficient confidence level to take action. Further, automated systems trained on existing fraudulent data may be prone to overfitting due to the limited positive fraud data associated with known fraudulent activity, the complexity of strategies and the wide diversity of frauds.

Some aspects of the present disclosure address some or all of the issues noted above, among others, by providing for the aggregation and augmentation of fund data for use in training a machine learning model to identify indicators of potential fraudulent activity. The data may include regulatory data associated with actions or announcements of a regulatory agency that investigates or enforces regulations or laws related to financial fraud. The data may include litigation data associated with fraud-related litigation. The data may include expert analysis (e.g., a report, a research paper, etc.) generated by a financial analyst investigating potential fraudulent activity. The data may include hedge fund disclosures like Private Placement Memorandums, risk disclosures. The data may include regulatory registration documents, like forms ADV. The data may contain public information individuals, firms and their known histories. The data may be aggregated from a variety of sources, that make available public data, including public sources (e.g., a website for a government entity, a court documents website, etc.) and private sources that may sell public data (e.g., formatted public data, deduplicated public data, aggregated public data, etc.).

As noted above, the available data may be limited in various ways. For example, many funds are not required to report data, and so information including return data may be limited. No portfolio manager wants to disclose their asset or strategy. Further, known instances of fraudulent activity are limited, and the amount of data associated with such instances is similarly limited. The system of the present disclosure may use the available data to generate additional data that may be used to train a machine learning model. For example, fraudulent activity may occur during a limited time for which a fund is operating. The system may divide the fund data for the fund into a plurality of time periods, and label time periods where fraud was known to occur with fraudulent activity and time periods where fraud was not known to occur with non-fraudulent activity.

Advantageously, generating additional training data may limit the risk of overfitting by the machine learning model during training. Further improving the granularity of the available data by labelling known periods of fraudulent activity with fraud provides additional positive fraud data that can be used by the machine learning model during training to identify indicators of fraud that may not have been apparent from analysis of the original information. Therefore, the system of the present disclosure may provide a more accurate machine learning model configured to identify potential fraudulent activity increasing the overall efficiency of a fraud indicator identification system and reducing the overall computing resources used to identify fraudulent activity. The above-described functionality of the system of the present disclosure further enables the system to consider significantly more available features of the aggregated data than prior systems. For example, while prior systems may have been limited to a few hundred or thousand features, the system of the present disclosure may analyze millions of features derived from the aggregated data due, in part, to the training of the machine learning model described herein allowing the trained machine learning to avoid overfitting of the limited existing training data prior to generation of the additional training data.

Further, data that may be used to identify potential fraudulent activity may be obtained from different sources (e.g., the data sources described above). However, each data source may refer to a same entity in different ways. Further, even data from a same data source may refer to the same entity differently across different data items. For example, a name of a fund may be abbreviated, misspelled, referred to based on an identifier used by the data source, or otherwise altered from the common name of the fund in different ways in different portions of the data. Similarly, a name of a fund manager may be different across different portions of the same data or data from different sources. For example, a first portion of data may use the fund manager's first and last name, and a second portion of the data may use only the fund manager's last name. In this example, multiple fund managers may have the same last name, and identifying the individual fund manager referred to by the last name may require additional analysis.

Therefore, the system of the present disclosure may use various methods to associate different data items that are related by being associated with the same fund, fund manager, and the like. For example, the system may analyze data items (e.g., public reporting, regulatory filings, litigation data, etc.) to identify entity information in the data items. The system may generate data items as a result of analyzing a data item (e.g., a data item may represent an analysis result). The system may then use other information in the data items (e.g., dates, return rates, assets under management, etc.) to associate the entity information across data items even where the entity information alone may not indicate that the data items refer to the same entity. Aggregating data items to group information associated with the same entity may result in improved model training data by providing additional information associated with fraudulent or non-fraudulent activity for use in training the machine learning model. Further, aggregating the data may enable improved accuracy of the identification of indicators of fraud when the machine learning model is executed.

The system may additionally generate a report that may include natural language description to explain why a potential indicator of fraud was identified by the machine learning model. For example, the report may include Shapley Additive Explanations (SHAP) to quantify the importance of individual features and enable a user or system to better understand the reasoning behind the identification of indicators of potential fraud. The report may be provided to a human reviewer for further analysis, enabling a second layer of validation of any identified indicator of potential fraudulent activity.

The term “machine learning model,” (“ML model”) as used in the present disclosure, can include any computer-based models of any type and of any level of complexity, such as any type of sequential, functional, or concurrent model. Machine learning models can further include various types of computational models, such as, for example, artificial neural networks (“NN”), language models (e.g., large language models (“LLMs”)), artificial intelligence (“AI”) models, multimodal models (e.g., models or combinations of models that can accept inputs of multiple modalities, such as images and text), and/or the like.

A Language Model is any algorithm, rule, model, and/or other programmatic instructions that can predict the probability of a sequence of words. A language model may, given a starting text string (e.g., one or more words), predict the next word in the sequence. A language model may calculate the probability of different word combinations based on the patterns learned during training (based on a set of text data from books, articles, websites, audio files, etc.). A language model may generate many combinations of one or more next words (and/or sentences) that are coherent and contextually relevant. Thus, a language model can be an advanced artificial intelligence algorithm that has been trained to understand, generate, and manipulate language. A language model can be useful for natural language processing, including receiving natural language prompts and providing natural language responses based on the text on which the model is trained. A language model may include an n-gram, exponential, positional, neural network, and/or other types of model.

A Large Language Model (“LLM”) is any type of language model that has been trained on a larger data set and has a larger number of training parameters compared to a regular language model. An LLM can understand more intricate patterns and generate text that is more coherent and contextually relevant due to its extensive training. Thus, an LLM may perform well on a wide range of topics and tasks. An LLM may comprise a NN trained using self-supervised learning. An LLM may be of any type, including a Question Answer (“QA”) LLM that may be optimized for generating answers from a context, a multimodal LLM/model, and/or the like. An LLM (and/or other models of the present disclosure), may include, for example, attention-based and/or transformer architecture or functionality.

While certain aspects and implementations are discussed herein with reference to use of a language model, LLM, and/or AI, those aspects and implementations may be performed by any other language model, LLM, AI model, generative AI model, generative model, ML model, NN, multimodal model, and/or other algorithmic processes. Similarly, while certain aspects and implementations are discussed herein with reference to use of a ML model, those aspects and implementations may be performed by any other AI model, generative AI model, generative model, NN, multimodal model, and/or other algorithmic processes.

Various aspects of the disclosure will be described with regard to certain examples and embodiments, which are intended to illustrate but not limit the disclosure. Although aspects of some embodiments described in the disclosure will focus, for the purpose of illustration, on particular examples of fraud types, data types, data sources, uses of a trained machine learning model, and the like, the examples are illustrative only and are not intended to be limiting. In some embodiments, the techniques described herein may be applied to additional or alternative types of fraud types, data types, data sources, uses of a trained machine learning model, and the like. Additionally, any feature used in any embodiment described herein may be used in any combination with any other feature or in any other embodiment, without limitation.

### Example Fraud Indicator Identification Environment

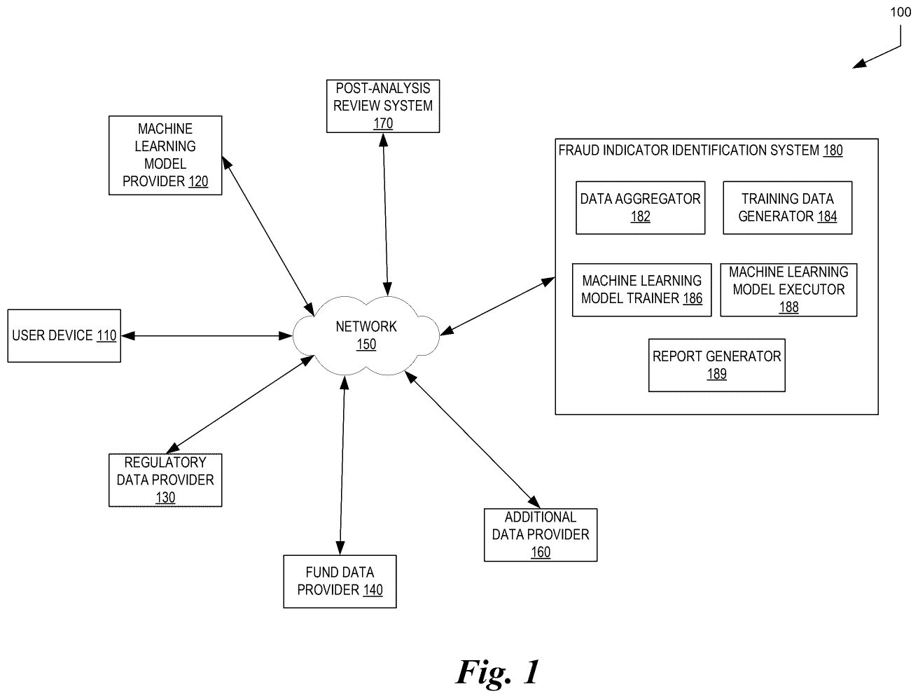

With reference to an illustrative example, FIG. 1 shows an illustrative environment 100 for identifying fraud indicators. The illustrative environment 100 comprises a user device 110, a machine learning model provider 120, a regulatory data provider 130, a fund data provider 140, a network 150, an additional data provider 160, a post-analysis review system 170, and a fraud indicator identification system 180.

The user device 110 may be a computing device associated with a user, for example a user that may provide a request to determine a fraud probability score to the fraud indicator identification system 180. The user device may include one or more inputs (e.g., a keyboard, a camera, a microphone, etc.). The user device may include one or more outputs (e.g., a speaker, a display, etc.). The user device may be used to provide an interactive user interface to allow the user to provide or access information associated with the fraud indicator identification system 180.

The machine learning model provider 120 is a computing system where machine learning models may be stored, accessed, or executed. Some of the models may be off-the-shelf libraries like SHAP to identify features, or standard neural network models used in many applications. Due to the particularity of the data analyzed and its enhancements, as well as the particularities of the problem at hand (at the intersection of hedge funds and investments, financial market theory on one side, fraud, litigation and the law on another), and the paucity, poorly labeled and noisiness of the data, most publicly available libraries are of limited value. For example, the machine learning model provider 120 may store a trained, or untrained, machine learning model that may be modified (e.g., trained, fine-tuned, etc.) by the fraud indicator identification system 180 for use in detecting potential fraudulent activity.

The regulatory data provider 130 is a computing system used to store legal and regulatory data. Legal documents may include articles of law, regulatory frameworks, past cases, interpretations thereof, as well as jurisprudential comments. This legal infrastructure is needed to understand and interpret hedge fund fraud. Regulatory data may include data associated with investigations, actions, or public statements made by a regulatory agency associated with regulating financial activity. The regulatory data provider 130 may be associated with regulatory agencies that have generated the data, or the official repositories of their actions and procedures. The regulatory data provider 130 may be a third-party data provider that gathers legal or regulatory data from one or more legal sources or regulatory agencies.

The fund data provider 140 is a computing system used to store fund data. Fund data may include incorporation information, official documents, disclosures of key personnel, total assets under management, changes in assets under management, a manager of a fund, a fund return rate, a fund risk tolerance, an asset class of assets traded by the fund, a management fee, a stated strategy or a list of permissible/restricted assets, or any other information associated with the operation of the fund. The fund data provider 140 may provide data for one or more funds associated with an entity. The fund data provider 140 may include a third-party data source that collects data from one or more funds or entities.

The network 150 may be a publicly accessible network of linked networks, some or all of which may be operated by various distinct parties, for example the Internet. In some cases, network 150 may include a private network, personal area network, local area network, wide area network, cellular data network, satellite network, etc., or some combination thereof, some or all of which may or may not have access to and/or from the Internet.

The additional data provider 160 is a computing system used to provide additional information to the fraud indicator identification system 180. The additional information may be information not provided by a regulatory data provider 130 or fund data provider 140. It could be referential libraries of financial instruments (bonds, stocks, options). It could be financial market or econometric information, like stock prices, unemployment numbers, or complex quantitative investment metrics like betas or factors. The data may include a referential of public information on personnel like past employment/employers, background checks, personal connection, social media, or addresses. Such data may be accessed with appropriate consent from an individual associated with the data. The data could be academic peer-reviewed papers or PhD thesis related to financial market theory. For example, the additional data may include a fraud analysis generated by a financial market analyst or another investment entity, data associated with consumer complaints, or other data that may be used as a potential indicator of fraud by the fraud indicator identification system 180 that is not provided by the regulatory data provider 130 or fund data provider 140.

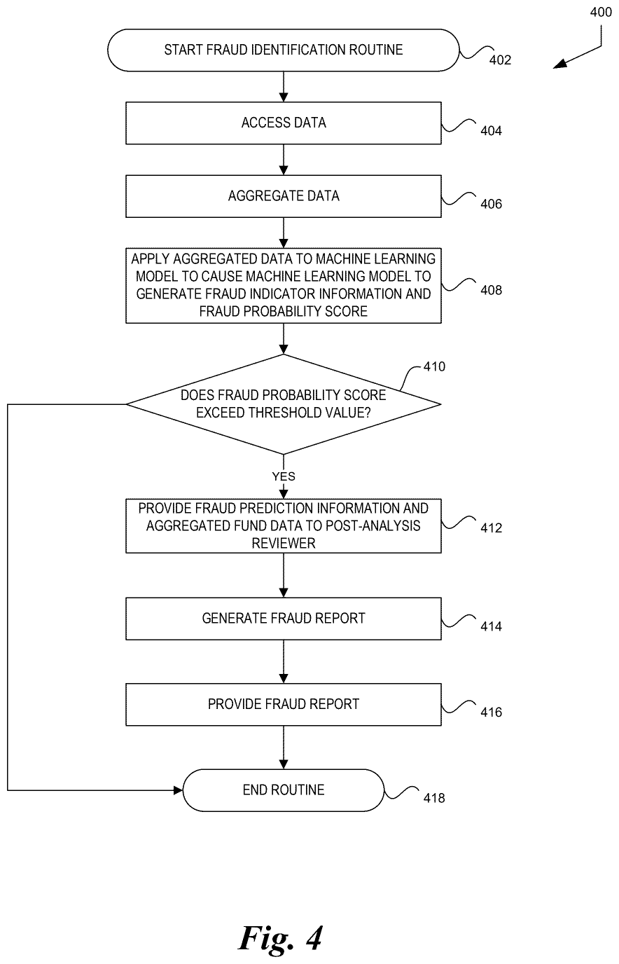

The post-analysis review system 170 is a computing system used to review the accuracy of the data in the regulatory data provider 130 or the fund data provider 140, or the additional data provider 160 or the output of the fraud indicator identification system 180. The post-analysis review system 170 may be an automated review system. For example, the post-analysis review system 170 may use a rules-based or a large language model-based or a machine learning-based approach to analyze the output (e.g., a report generated by the report generator 189) to determine any areas where a potential error may have occurred (e.g., by reviewing the reasoning generated by the machine learning model executed by the machine learning model executor 188 described in further detail with respect to FIG. 4 below herein). In some embodiments, the post-analysis review system 170 may provide information to a human reviewer for analysis and validation.

The fraud indicator identification system 180 is a computing system used to train or execute a machine learning model to identify potential fraud based on fund data. The fraud indicator identification system 180 of this example illustrative environment 100 includes a data aggregator 182, a training data generator 184, a machine learning model trainer 186, a machine learning model executor 188, and a report generator 189.

The data aggregator 182 is an element of the fraud indicator identification system 180 that aggregates data from various sources (e.g., the regulatory data provider 130, fund data provider 140, or additional data provider 160) for use in the training or execution of a machine learning model by the fraud indicator identification system 180 to identify potential fraudulent activity.

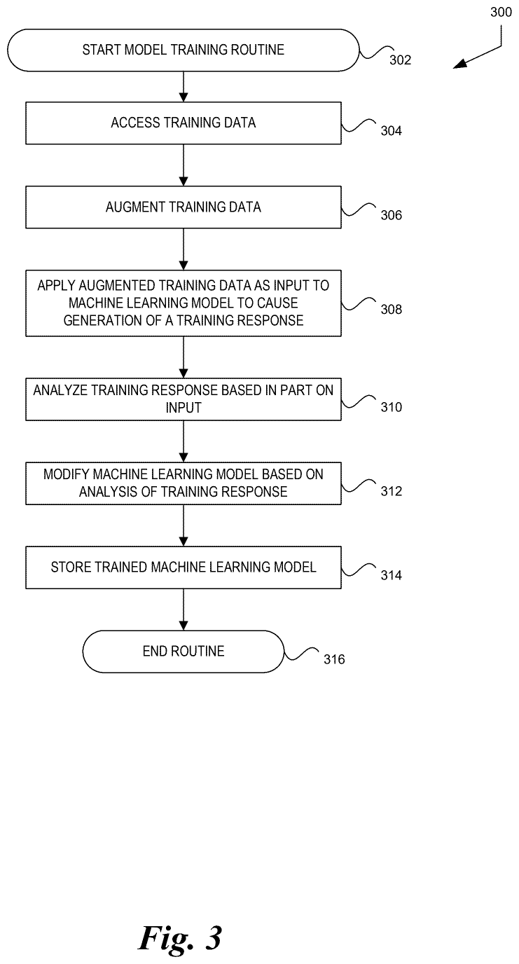

The training data generator 184 is an element of the fraud indicator identification system 180 used to generate additional training data for a machine learning model trained by the machine learning model trainer 186 to identify potential fraudulent activity. The generation of training data is described in further detail with respect to FIG. 3 below herein.

The machine learning model trainer 186 is an element of the fraud indicator identification system 180 used to train a machine learning model to identify potential fraudulent activity based on fund data. The machine learning model trainer 186 may train the machine learning model as described in further detail with respect to FIG. 3 below herein.

The machine learning model executor 188 executes a machine learning model of the fraud indicator identification system 180 to identify potential fraudulent activity, for example as described with respect to FIG. 4 below herein.

The report generator 189 generates a report based at least in part on the output of a fraud analysis system or one of the machine learning models executed by the machine learning model executor 188 to identify potential fraudulent activity, as described with respect to block 416 of FIG. 4 below herein. The report generator 189 may also generate intermediary or specific reports, which are sent back to the post-analysis review system 170 for independent review when accuracy is critical.

### Example Fraud Risk Identification Training and Execution Routines

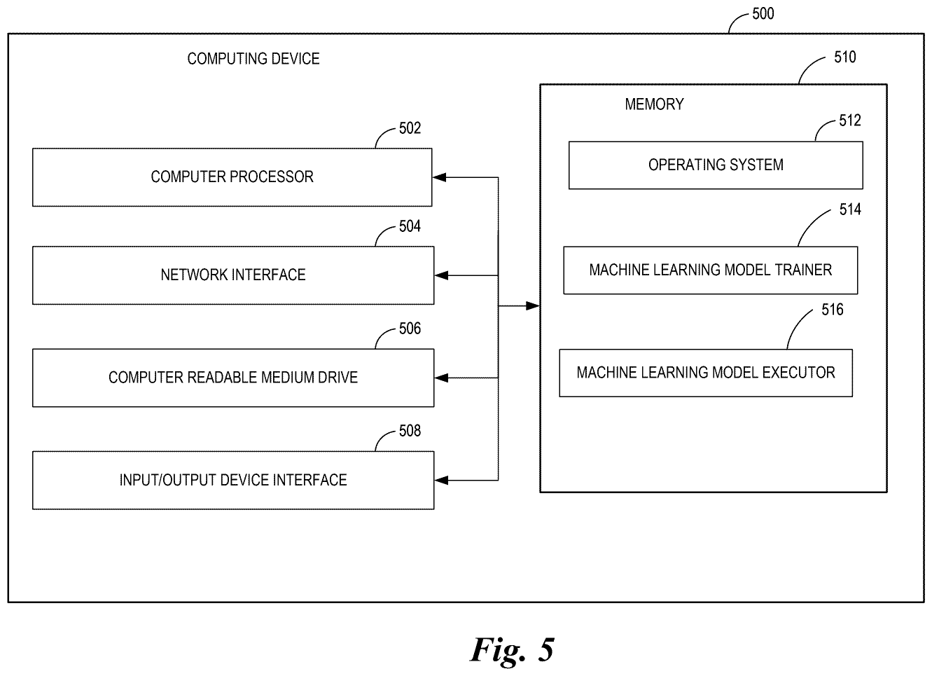

When a routine descried herein is initiated, a set of executable program instructions stored on one or more non-transitory computer-readable media (e.g., hard drive, flash memory, removable media, etc.) may be loaded into memory (e.g., random access memory or RAM) of a computing system, such as the computing device 500 shown in FIG. 5, and executed by one or more processors. In some embodiments, the routines or portions thereof may be implemented on multiple processors, serially or in parallel. Further a routine described herein may be performed in a different order, or may emit blocks, in some implementations.

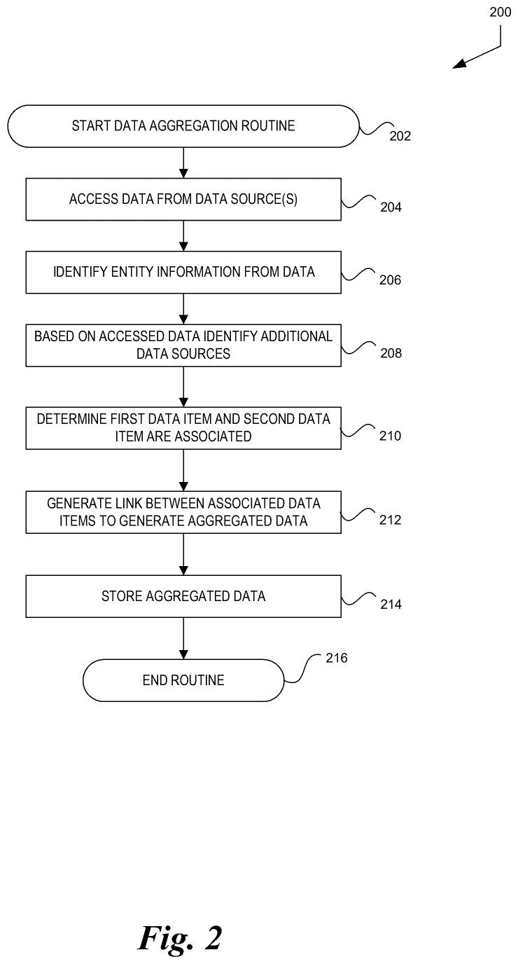

FIG. 2 illustrates example routine 200 for aggregating data to generate aggregated data for training or executing a machine learning model to identify fraud indicators. The routine 200 begins at block 202, for example in response to a request from a user or system to aggregate data for use by the fraud indicator identification system 180. In some embodiments, the routine 200 is a continuous process, and data may be aggregated at regular intervals, or irregular intervals. In some embodiments, data may be automatically received at the fraud indicator identification system 180, and the data aggregator 182 may aggregate the newly received data with previously stored data in response to receiving the data.

At block 204, the data aggregator 182 accesses data stored by one or more data sources. Data sources from which the data aggregator 182 may access data include the regulatory data provider 130, fund data provider 140, or an additional data provider 160. Their outputs may have been verified by 170. Data accessed by the data aggregator 182 may include financial data, regulatory enforcement data, investigation data, third-party analysis data, litigation data, or other data associated with the operation of a hedge fund organization, a specific fund, or a manager associated with a hedge fund organization or individual fund. In some cases, data access may be restricted to particular systems, users, or entities, and the data aggregator 182 may access a credential associated with a system, user, or entity with access to the data. Further, some data may be stored in a database structure. To access data stored in a database, the data aggregator 182 may generate or access a query configured to return relevant information from the database.

When accessing data from a data source, the data aggregator 182 may filter the accessed data to reduce the amount of irrelevant data, or data that is otherwise not useful for the fraud indicator identification system 180 to identify fraud indicators. The data aggregator 182 may select not to further store or process the irrelevant data accessed from the data source. For example, litigation data may be accessed by the data aggregator 182 during data aggregation. However, some litigation data may be related to non-fraud litigation (e.g., consumer product liability, shareholder liability, etc.). The data aggregator 182 in this example may select not to further process or store the non-fraud litigation data, while continuing to obtain, process, or store the fraud-related litigation data. In some embodiments, the data aggregator 182 may use a machine learning model to determine whether data is relevant to the fraud indicator identification system 180. For example, the data aggregator 182 may apply data as input to a machine learning model trained to classify data as relevant or irrelevant to the fraud indicators generated by the fraud indicator identification system 180. The data aggregator 182 may then select to further process, or not to further process, data items based on the output of the machine learning model.

At block 206, the data aggregator 182 identifies entity information from the data. Entity information may include a name of an individual person (e.g., a fund manager, an employee of an investigation or enforcement unit of a regulatory agency, a judge, etc.), a name of an individual fund, a name of a hedge fund including multiple individual funds, an identifier for an enforcement agency (e.g., Securities and Exchange Commission, SEC, S.E.C., etc.), an identifier for a court district, an identifier for a court, a name of a data source, or other identifier or name that indicates an individual or entity associated with at least a portion of the data. To determine the entity information, the data aggregator 182 may use a machine learning model trained to take data as input and generate an output identifying entity information contained in the data. The entity information contained in the data may be included in information (e.g., fund performance information, enforcement information, litigation information, etc.) or in metadata associated with the information. In some embodiments, the output of the machine learning model may be a structured output including entity information and an indication of the portion of the data associated with the entity information. In some embodiments, entity information may include time information. For example, agency enforcement action information may indicate that an individual was assessed a fine for conducting fraudulent activity, in which he may have manipulated returns over the period of investigation. In this example, fund information may indicate that a portion of the fund's returns may not be credible over that period, which the machine learning model trainer would be able to highlight. The model would then detect un-credible returns as an indicator of fraud going forward. Time information may also be corroborated with the individual's reported employment at the fund, due to his employment record or the firm's regulatory disclosures.

Advantageously, using a large language model (LLM) to identify entity information from the data may assist in the grouping of documents or data associated with a same entity but is identified in different ways between different data sources. For example, a document in a first dataset may include fraud investigation and enforcement information for a fund which indicates the U.S. “Federal Bureau of Investigation,” an entity. A second document may include litigation information related to fraudulent activity but refer to “F.B.I.”, an abbreviation of the same entity. The large language model may determine that the “Federal Bureau of Investigation” and the “F.B.I.” are the same entity, and that the two datasets are related. The output generated by the large language model may indicate that the “Federal Bureau of Investigation” and the “F.B.I.” are the same entity and will resolve the discrepancy between the two documents. This difficulty is endemic. Between acronyms, abbreviations, and misspellings (below), a review has highlighted at least 286 different spellings for “SEC” just inside the SEC's documents. Entity names and people names have many similar variations. This output indicating that the two titles refer to the same entity may then be used by the data aggregator 182 when aggregating data.

In some embodiments, the identification of entity information may be supplemented by a list or other data structure indicating various names for a same entity. For example, a list, table, or other data structure may include U.S. government agencies that would be expected to be involved in the investigation of fraudulent activity. The data structure may further indicate known aliases for the U.S. government agencies. Additionally, the data structure may indicate common misspellings, or alternate spellings of an entity's name. For example, an individual may have a name where at least one letter includes an accent (e.g., è, ç, ö, etc.). A common alternate spelling of such a name may include the letter without the accent. Documents are often pdfs or scans of printouts. These unstructured documents must first be converted from into computer-readable files through an “Optical Character Recognition” (OCR) process, which generates many spelling errors.

At block 208, the data aggregator 182 identifies any additional data sources from which data is to be accessed based on previously-accessed data. For example, the data aggregator 182 may access regulatory data indicating that a litigation action against an entity or individual is/was litigated in court. The data aggregator 182 may then determine a location of the litigation action (e.g., the court in which the action has been filed). Based on the determined location of the litigation action, the data aggregator 182 may access the court records system to obtain the data associated with the litigation action. In another example, a name of an individual may be indicated as a fund manager of an investment fund. The data aggregator 182 may determine similar names, or previous names (e.g., due to a name change) from the entity information and access additional information related to the fund manager. Accessing additional data based on the previously-accessed data may assist in obtaining a sufficient volume of data related to an entity to enable training or execution of a fraud indicator identification model.

In some embodiments, additional data may be accessed based on a time interval having passed in place of using previously accessed data to identify additional data sources. For example, the data aggregator 182 may access one or more data provider systems (e.g., regulatory data provider 130, fund data provider 140, or additional data provider 160) at a time interval to identify additional data not previously retrieved by the data aggregator 182 (e.g., at block 204). In some embodiments, the data aggregator 182 may access additional data at different time intervals for different data provider systems. For example, the data aggregator 182 may access additional data from a fund data provider 140 daily, and from a regulatory data provider 130 once per week. A time interval may be fixed or dynamic. A fixed time interval may be a set number of minutes, hours, or data between attempts to access additional data from a data provider system. For example, the data aggregator 182 may be configured to access additional data at 12:01 AM each day from one or more of the data provider systems. A dynamic time interval may change based on various factors, such as the amount of data last received from a data provider system, a current volume of data being processed by the data aggregator 182, or any other factor that may be considered for varying the frequency with which additional data is accessed.

At block 210, the data aggregator 182 determines a first data item and a second data item of the accessed data are associated. In some embodiments, the data aggregator 182 may determine a first data item and a second data item are associated based on entity information associated with each data item. In some embodiments, the data aggregator 182 may determine a first data item and a second data item are associated based on the first data item and second data item being associated with a same instance of fraud. The first data item and the second data item may be from a same data set. For example, a government agency enforcement action database may include investigation results and enforcement actions associated with a hedge fund over several years. However, over the timeframe of the dataset, the hedge fund name may change, be incorrectly spelled, be abbreviated, or otherwise be inconsistent between individual entries in the dataset associated with the hedge fund. The data aggregator 182 may use the entity information identified in the data to connect the information associated with the same hedge fund even when the identifier used for the hedge fund has changed or been incorrectly entered. For example, litigation documents may be accessed from a court website and an agency. However, the litigation documents may use different identifiers for a same party (e.g., due to different abbreviations of a party name), incorrectly be associated with a case number (e.g., due to a typographical error) or otherwise store the litigation data such that data items associated with the same litigation are not clearly identifiable as associated with the same litigation. The data aggregator 182 may then automatically analyze litigation documents from the court and agency websites, in this example, to determine that a first data item and a second data item refer to the same litigation. In some embodiments, the first data item and the second data item may be from different datasets. For example, a first dataset may be financial information associated with a hedge fund, and a second dataset may be litigation information associated with a particular court. Each of the financial information and the litigation information may use different identifier structures (e.g., different ordering in names, different abbreviations, etc.) for an entity or may include errors in the identifier for the entity. The data aggregator 182 may use entity information identified in each of the first dataset and the second dataset to determine the first data item and the second data item are associated.

In some embodiments, the data aggregator 182 may use return data to determine that a first data item and a second data item are associated with the same entity. For example, a first data item may indicate a fund has a percentage return rate, dollar value return, or other indication of a return for an entity. A second data item may then be identified by the data aggregator 182 indicating that an entity associated with the second data item has a same or similar (e.g., within a threshold difference) return to the entity in the first data item. Comparing the return information from each of the first and second data items over time, or individually, may enable the data aggregator 182 to determine that the same entity is associated with each of the first data item and the second data item.

In some embodiments, the data aggregator 182 may apply at least the first data item and the second data item as input to a machine learning model trained to generate clusters of similar data items (e.g., data items associated with a same entity). The first data item and the second data item may then be associated based on the output of the machine learning model. In some embodiments, the data aggregator 182 may generate an embedding representation of at least a portion of the data input to a machine learning model used to generate associations between data and entities. For example, the data aggregator 182 may use a first machine learning model to generate embeddings from one or more data items. The data aggregator 182 may then apply the embeddings as input to a second machine learning model configured to perform a semantic search, or other vector similarity-based search, to cause the second machine learning model to generate an indication of an association between data items based on the result of the search. Advantageously, generating an embedding from at least a portion of the input data may enable the data aggregator 182 to provide more information as input to an input size-limited machine learning model while maintaining the ability of the machine learning model to identify similar data that may be associated with the same entity. Further, the data aggregator 182 may use multiple methods of determining a first data item and a second data item are associated with the same entity, for example to allow for a check (e.g., a sanity check) of the correctness of the association of each data item with the entity.

In some embodiments, the data aggregator 182 may determine data items associated with a document type (e.g., litigation documents, financial return documents, regulatory filings, etc.) are associated. For example, the data aggregator 182 may receive a plurality of litigation documents (e.g., documents filed with a court, evidence made publicly available, etc.) from different data sources. The data aggregator 182 may apply the plurality of litigation documents as input to a machine learning model to cause the machine learning model to determine a first data item and a second data item are associated. The machine learning may, in some embodiments, identify an association in litigation documents based on the litigation or portion of litigation (e.g., trial court documents, appeal documents, etc. associated with a same litigation) with which portions of the plurality of litigation documents are associated (e.g., as described further in block 212 below).

In some embodiments, the machine learning model may extract entity information (e.g., as described at block 206 above herein) when determining a first data item and second data item are associated. In some embodiments, the machine learning model may correct, or standardize, entity information in the documents determined to be associated. For example, if a first document refers to a company by the name Hedge Fund Provider, Inc., and a second document refers to the same company by the name The Hedge Fund Provider Incorporated, the machine learning model may generate a standardized name for the company that will be applied to documents (e.g., by modifying the documents, associating a company name label as metadata with each document, etc.) when the documents are clustered. Such standardization of entity name information may result in an improved ability of a machine learning model or other system to locate and analyze the clustered documents.

In further embodiments, when determining data items are associated, a machine learning model may extract fraud-related information from the associated data items. The fraud-related information may be extracted from a first data item, and the fraud-related information may be associated with a second data item determined to be associated with the first data item that may not have previously included fraud-related information. In some embodiments, the data aggregator 182 may connect a fraud data item (e.g., a data object including known information related to a fraud event) with a second data item (e.g., accessed from a regulatory data provider 130, fund data provider 140, or additional data provider 160). For example, the fraud data item may be related to a data item associated with a particular fund. The fraud data item may be associated with the data item in this example based on a probability generated by a model. The probability may indicate a likelihood the fraud data item is associated with the data item or the fund generally, for example based on the probability exceeding a threshold value. The data aggregator 182 may transmit a determination that a fraud data item and a data item associated with a fund are related based on a probability to the post-analysis review system 170 for additional evaluation or confirmation. In some embodiments, a fraud report may be generated by the machine learning model to summarize the fraud-related information.

As described previously herein, there is a limited availability of positively-labeled fraud data (e.g., data items known to be associated with an instance of fraud). Determining associations between data items as described herein allows the fraud indicator identification system 180 to generate significantly more positively-labeled fraud data based on the determined associations. The additional positively-labeled fraud data enables improved training of machine learning models to identify fraudulent activity by augmenting the available positively-labeled data. Such an improvement to the training of machine learning models based on the additional positively-labeled data results in an improved machine learning model that is better able to automatically identify potential fraudulent activity as compared to previous systems. Further, existing available data may have significant numbers of unlabeled positive fraud data, that is data that is associated with a known instance of fraud but that is not labeled as associated with the fraud. Associating data items as described herein reduces the amount of unlabeled positive fraud data, reducing the noise of the data used to train a machine learning model to identify potential fraudulent activity. Such a reduction in data noise in training data results in a trained machine learning model that is able to more accurately or efficiently identify potential fraud.

At block 212, the data aggregator 182 generates a link between associated data items to generate aggregated data. The data aggregator 182 may generate a link between the data in various ways. For example, the data aggregator 182 may have determined a first data item and a second data item are associated with the same entity, and add metadata associated with each data item indicating the entity with which they are associated. The metadata identifier may be a standardized identifier used by the fraud indicator identification system 180 to represent the entity. The standardized identifier may be a common identifier (e.g., a name or nickname) for the entity, a numeric identifier that may be mapped to various entity names for the entity in a lookup table, or other identifier that enables the fraud indicator identification system 180 to determine the data is associated with the entity without additional identification of entity information from the data at a later time.

In another example, a data structure (e.g., a table, database, etc.) may contain data items associated with an entity (e.g., as rows) and the fraud indicator identification system 180 may add additional data items determined to be associated with the entity to the data structure (e.g., as the additional data items are identified). Where data items are added to an existing table, the data items may include various information types that are not found in previously stored data items and may add additional columns to the table to represent such additional information types. Generating links between data associated with the same entity enables the data aggregator 182 to aggregate the data related to the entity.

In some embodiments, the data aggregator 182 may standardize information associated with an entity when data items associated with the entity are linked. For example, the data aggregator 182 may apply a formatting operation to data items being linked to an entity. The formatting operation may maintain the existing information in the data in a standardized format used by the fraud indicator identification system 180 generally. Further, information associated with the data item may be standardized. For example, an investment company may have several classes of shares, some denominated in USD, some in Euros, some in GBP. The data aggregator would convert the various currencies into a single reference currency, say USD, and aggregate the different AUMs into the company's total AUM. Alternatively, a fund may have a few separate but similar strategies, which are warehoused in different legal structures (say both companies deploy a complex quantitative strategies on the S&P 500 universe, but one of the funds refused to trade tobacco or gambling shares into consideration). Alternatively, the two funds may have the same strategy, but the companies differ by their fee structures or their permitted investor classes. The data aggregator 182 may identify these legal structures as very similar, and aggregate them into one single strategy or fund, for the purpose of AUM calculation. Advantageously, standardizing the format of the data items may make access and retrieval operations more efficient by allowing the fraud indicator identification system 180 to use a formatted prompt or query to enable access to all data relevant to the prompt or query with a significantly reduced risk of missing data based on an incorrect entity identifier or other identifier. For instance, one of these companies may state the name of its portfolio manager, but not the other company. If the two companies are deemed the same by the data aggregator 182, then the portfolio manager is likely the same for both companies. Further, standardizing the representation of information in the data item may reduce a risk of accidental misunderstanding or misrepresentation of the information during analysis.

In some embodiments, the data aggregator 182 may determine a first data item including information related to a fraud is associated with a second data item, and label the second data item as being associated with fraud.

At block 214, the data aggregator 182 stores the aggregated data for later use. The data aggregator 182 may store the aggregated data in a data storage location of the fraud indicator identification system 180. The data aggregator 182 may store the aggregated data in a remote storage location (e.g., provided by a cloud provider). The stored data may be secured to reduce the risk of unauthorized access to the data. In some embodiments, the data aggregator 182 may store an embedding representation of the data. The embedding representation may be stored in place of, or in addition to, the data in a non-embedding format. The embedding representation may be useful for efficient processing or searching of the stored data by a machine learning model (e.g., the embedding search described with respect to block 210 above herein). In some embodiments, at least a portion of the aggregated data may be provided to the post-analysis review system 170. At the post-analysis review system 170, a human reviewer, automated system, or combination of the two may review the aggregated data to determine whether the aggregation of the data was correct. When the data aggregator 182 has stored the data, the routine 200 moves to block 216 and ends.

### Model Training

FIG. 3 illustrates example routine 300 for training a machine learning model to identify fraud risk indicators. The routine 300 begins at block 302, for example in response to a request from a user associated with the fraud indicator identification system 180 or a user device 110 requesting training of a machine learning model. In some embodiments, the routine 300 may begin in response to a new machine learning model becoming available, for example from a machine learning model provider 120.

At block 304, the training data generator 184 accesses training data to be used to train the machine learning model. The training data may be based, at least in part, on data aggregated by the data aggregator 182 (e.g., as described above with respect to routine 200 of FIG. 2). The training data may include training data previously used to train a machine learning model. The training data may include at least some data that is augmented training data, described with respect to block 306 below, generated by a previous operation of the routine 300. The training data may include at least one positively labeled data item, and at least one negatively labeled data item. A positively labeled data item, as used herein, may refer to a data item associated with a known instance of fraudulent activity or a data item determined by the fraud indicator identification system 180 to be associated with a possible or probable instance of fraud (e.g., using one or more of the methods described below for augmenting the training data at block 306). A negatively labeled data item, as used herein, may refer to a data item which is unlabeled with respect to fraudulent activity, or a data item that has been associated with a label indicating that no fraudulent activity has occurred. In some embodiments, the training data generator 184 may deduplicate the accessed training data. For example, a copy of a same filing may be obtained from a fund data provider 140 and a regulatory data provider 130. The training data generator 184 may identify the duplicate filing from each source and remove a duplicate copy from the training data (e.g., until only one copy of the filing remains in the training data). It may also group documents related to the same fraud, or summarize all these documents into a single review, or extract key elements among the cluster, like names of individuals and entities, nature of the fraud, period of fraud or resulting sanctions. or extract key information in groups of documents. The training data generator 184 will also handle much more quantitative and cross-sectional tasks, like eliminating implicit correlations or reducing the dimensionality of the training data.

At block 306, the training data generator 184 augments the training data. Augmenting the training data may include associating a known fraudulent activity with at least a portion of the data (labeling). Several technical challenges exist in associating a known fraudulent activity with data associated with an entity, as discussed in detail previously herein. For example, fraudulent activity may occur over a limited time period, and the training data generator 184 may augment the training data by indicating that the data associated with the time period is associated with fraudulent activity. The training data generator 184 may analyze which style of strategy the fund is deploying or analyze if the returns are credible for the stated strategy, or if the returns can be explained based on the stated asset classes, or detect if massaging techniques have been used (with methods like Benford's law), or compare returns between similar funds, to see if cherry-picking is detectable with sufficient statistical accuracy. The training data generator 182 may calculate consistency tests of any complexity, over various time scales, either in absolute or in comparison to peers, of any data explicitly stated or obtained through augmentation. For example, comparative metrics (e.g., correlations, Pearson's r, regression betas, R², Spearman's Rank Correlation Coefficient, Kendall's Tau) may be used to calculate consistency.

Further, as fraudulent activity may begin prior to the known fraudulent activity and enhance its analysis of the period in question. The training data generator 184 may associate data from a time period prior to the known fraudulent activity with a potential fraud indicator and detect yet unknown patterns connecting some or part of the data with fraudulent activity, which it can then use to analyze other funds. In another example, fraudulent activity may be associated with a portion of the funds available from an entity, but not all funds associated with the entity, and the training data generator 184 will look for differences between the funds. The training data generator 184 may then determine to associate the fraudulent activity indicator with the portion of data associated with the fund, or with another entity associated with the fraud (e.g., a fund manager associated with the funds having known fraudulent activity), as well as the many enhancements created by the training data generator 184.

In some embodiments, the machine learning model trainer 186 may generate additional training data using the training data generator 184. As discussed previously herein, the amount of data for known fraudulent activity may be a small portion of the overall data available for use in training a machine learning model of the fraud indicator identification system 180. Merely reducing the total dataset does not adequately address this lack of data. For example, the reduced dataset may lead to overfitting of a trained machine learning model to the limited examples of fraud available in the training data. In another example, the reduced dataset may not be of sufficient size to result in a trained machine learning model capable of generating an accurate indication of potential fraudulent activity. Accordingly, the training data generator 184 may be used to generate additional training data from the existing data to enable a more efficient and accurate machine learning model trained to generate an indication of potential fraudulent activity.

To generate additional training data, the training data generator 184 may access data associated with known fraudulent activity. As noted previously, known fraudulent activity may be associated with a timeframe. The timeframe of known fraudulent activity may be different from the timeframe into which data for an entity associated with the known fraudulent activity is divided. The training data generator 184 may subdivide the data in the time dimension for the entire universe of funds for the purpose of generating additional data points, where generated data occurring during the period of known fraudulent activity is also associated with the known fraudulent activity, and generated data associated with a time outside of the timeframe of the known fraudulent activity may be associated with an indicator of no known fraud or potential unknown fraud (e.g., data for a time immediately prior to the timeframe of the known fraudulent activity may be labelled as associated with potentially unknown fraud). In some embodiments, some or all of the additional data generated from data associated with known fraudulent activity may be labelled as associated with known fraudulent activity. In other embodiments, the training data generator 184 may calculate features over periods of time of various lengths and optimize their lengths to render the features most meaningful. The determination of which additional data to label as fraudulent activity may be based on additional factors, such as continuity of management of the fund associated with the data during periods of time associated with fraudulent activity, other known fraudulent activity of the entity managing the fund, or other information that may indicate a same or different entity had decision-making authority over the fund during or outside of the period of known fraudulent activity. In some embodiment, the training data generator 184 may look at actual market events (like market rallies and depressions, periods of high volatility, periods of high unemployment, or period of lower economic activity, or more complex periods) to generate features which are cross-sectional to all funds but are significant to a particular fund in a quantity specific to the fund.

Further, in some embodiments, an individual may be associated with known fraudulent activity. The data directly associated with the known fraudulent activity (e.g., based on the data being represented in litigation or enforcement data) may be labeled as associated with known fraudulent activity. To augment the training data, the training data generator 184 may assume that the individual associated with the known fraudulent activity is likely to have committed other fraud. The training data generator 184 may then label additional data associated with the individual as associated with known fraud. In some embodiments, associating additional data with known fraud based on an individual may further be based on the position of the individual with respect to the fund associated with the data. For instance, the training data generator 184 may detect that the CFO of a current fund used to work as an accountant for Madoff's Ponzi, or that his personal litigation history reveals a pattern of deception, or that his background checks have detected red flags in his employment history or in his spending habits, or that his spouse or a previous business partner are exposed to fraudulent activities, which would all constitute a risk going forward. For example, the training data generator 184 may label data associated with funds where the individual was a fund manager as fraudulent, but not data associated with funds where the individual was executing trades under a fund manager.

In some embodiments, additional factors may be used to augment the training data and determine additional data that may be associated with fraudulent activity. Factors may include return information, asset allocation, redemption terms for withdrawal of funds, investor information, management information (e.g., a frequency of change in management of the fund, an identity of a fund manager, etc.), a sudden change in the size of the assets under management, or an AUM which is not sufficient to justify the number of employees, a value proposition of an investment of the fund (e.g., a determination of whether the fund is investing in potentially undervalued assets), legal incorporation structure, volatility of fund assets or returns, an asset class of assets traded by the fund which are not permitted in the representations, a trading style of the fund (e.g., quantitative, Commodities Trading Advisors CTA, long/short equity, emerging markets, etc.), or any other factor associated with the management or performance of a fund.

For example, regressions on return information included in data associated with a fund may be used to determine one or more asset classes likely to be included in the assets of the fund where the list of assets is not publicly available. The training data generator 184 may analyze (e.g., using a machine learning model, a regression model, a human reviewer, etc.) the return information for a fund from the available data. The training data generator 184 may determine, based on the data associated with the fund, that the fund describes itself (e.g., in regulatory filings, public advertisements, etc.) as investing in a first class of assets (e.g., stocks). The training data generator 184 may determine from the return information for the fund that the value of the returns (e.g., percentage rate of return on investments) does not align with the indicated first class of assets. The training data generator 184 may determine a second class of assets (e.g., commodities) for which the return information does align. The training data generator 184 may then augment the data by indicating the likely asset being traded by the fund, here the second class of assets. Where the likely asset being traded and the asset indicated as being traded by the fund do not align, the training data generator 184 may associate the fund data with potential fraudulent activity and label the data as such for training of the machine learning model.

Further, the training data generator 184 may access a set of known fund investment strategies (e.g., an investment style) that are commonly used by funds. The training data generator 184 may compare the known fund investment strategies with data associated with a fund to determine which strategy is being employed by the fund. The training data generator 184 may then identify potential anomalies in the data based on a mismatch in the strategy being employed and other fund data (e.g., return data, public advertisement, regulatory filing, etc.) and generate additional training data indicating that this mismatch may indicate fraudulent activity. For example, a mismatch may be determined based on a significantly (e.g., outside of a statistical probability) different return rate for the fund as compared to other funds' return rates that used a similar strategy over a similar period of time. For example, a given fund may not have been sensitive to the market downturns following the dotcom crash, or the mortgage derivatives crash, or the COVID crash, while all its peers were. The training data generator 184 also augments the training data with indicators of overfitting, accuracies of calculations and other quantitative/qualitative metrics of model efficiency. The training data generator 184 also increases the quality of the training data by eliminating undue correlations or overlaps between the different datasets (“dimensionality reduction” techniques). Augmenting the training dataset may actually lead to a reduction or eliminating parts of the dataset.

It should be understood that the above description of data augmentations by the training data generator 184, while described individually, may in some cases be combined at least in part to generate additional training data, or verify the internal consistency of the training data, or qualify the accuracy of the training data, or assess the quality and pertinence of the augmented data. The training data generator 184 may then augment the training data to indicate that at least portion of the data associated with the fund is associated with potential fraudulent activity. Further examples of data determinations that may be made by the training data generator 184 and used to augment data to indicate potential fraud include the following:
An employee of a fund may have been associated with past regulatory, civil, or criminal violations, or are connected with individuals or firms which have been associated with such events;
An employee of a fund may have provided incorrect personal information;
A fund may have poor controls (e.g., lacking a dedicated compliance officer), or may have custody of client assets, or be trading with its investors (e.g., generating risks of conflicts of interest, front-running, or other improper activity), or have a very concentrated client base or no institutional client;
A fund's providers (auditors, accountants, prime brokers, or others) may be determined to be of poor quality;
An analysis may indicate that the fund is investing in Bitcoin or other digital assets, a commodity, or an asset class, which is in conflict with the fund's permissible investment universe or its strategy representations;
A fund's comparisons to asset classes, instruments, strategies, factors, geographies, or styles may reveal inconsistencies with its statements, with its peers, or across time;
A fund's performance metrics, such as its Sharpe ratio or its outperformance to the S&P 500 or its frequency of bad/good months may be inconsistent with its peers, with industry standards or with known statistical, econometric or financial market theory; or
A fund may have performed unlike its peers during large market movements, or complex scenarios (such as dotcom, real-estate credit, or COVID crisis), or in ways that are inconsistent with the indicated strategy, or its risk disclosures, or any statements of the fund or its managers as determined by an analysis of the fund's available information.

Or that any or all of these augmented data points may be inconsistent with each other, or inconsistent in time, or statistically unlikely, or may become significant or inconsistent or statistically unlikely when combined. Each of the above examples is exemplary, and the training data generator 184 may use one or more of the above examples alone or in combination to determine that fund data associated with a fund is likely to indicate fraudulent activity. The training data generator 184 may then label the fund data as likely fraudulent. Some of the above examples used to determine potential fraud for augmenting data may further be analyzed by a machine learning model (e.g., during training of the machine learning model at blocks 308-312) to identify analyses or determinations that are most strongly associated with fraudulent activity. The high number of combinations may result in data with high dimensionality, from which the trained machine learning model described below herein will identify dimensions that are most likely to be associated with fraud.

Advantageously, as significant amounts of fraudulent activity may normally go undetected, some tolerance for improper identification of potential fraudulent activity may not affect the overall performance of the trained machine learning model and augmenting the training data in the above-described way may result in a more accurate machine learning model for detecting potential fraudulent activity than a machine learning model trained on only known fraudulent activity data. The model trainer 186 achieves training of more accurate machine learning models based in part on the training data generator 184 generating additional training data samples associated with positive fraud indicators in the manner described above, resulting in increased predictive capacity while controlling for a reduced overfitting of the trained model to positive samples as compared to training on non-augmented (e.g., the originally available) training data. Further, using the additionally generated training data to train the machine learning model may improve accuracy of the trained machine learning model compared to previous models by reducing problems with noisy training data that may, as described previously, include significant numbers of unlabeled fraudulent events.

At block 308, the machine learning model trainer 186 applies the augmented training data as input to a machine learning model to cause the machine learning model to generate a training response. The machine learning model may be an untrained model, general trained model (e.g., trained on a large corpus of data from various fields that may or may not include financial data), previously trained or fine-tuned model (e.g., by a previous operation of the routine 300), or other machine learning model provided by the machine learning model provider 120. In some embodiments, the machine learning model trainer 186 may train a copy of the machine learning model, for example using resources of the fraud indicator identification system 180. In some embodiments, the machine learning model trainer 186 may provide the augmented training data to the machine learning model provider 120 (e.g., via the network 150) to cause the machine learning model provider 120 to train the machine learning model based on the provided augmented training data.

Many publicly available models may not be capable of handling data at the level of detail provided by the fraud indicator identification system 180, notably the high dimensionality of the data, low number of rows, or the many potential unlabeled positives. Further, existing models may only be able to be applied to a portion of the data (e.g., due to the varying data structures or data types), or for some specific analysis (e.g., a model trained to perform a single type of analysis). Many current models makes use of dimensionality reduction (e.g., using principal component analysis) to manage the significant number of variables present in the data described herein. Dimensionality reduction for input data results in less data from which a model can generate a prediction. Accordingly, the resulting prediction from a model using a lower-dimensional representation of the input data may be less accurate, or in some cases result in the model being unable to provide a conclusive result. However, use of dimensionality-reduction techniques may cause a lack of explainability for a result generated by a model. For example, if a model eliminates the components of the 99,999 previous dimensions in the 100,000th factor, then the model may create a new feature which is uncorrelated to the 99,999 previous ones, but it has become a complex average of 100,000 features, which has lost all signification for the human user/reviewer. The models of the present disclosure may address this problem by reducing the dimensionality implicitly during generation of a result (e.g., during inferencing by a trained machine learning model trained by the machine learning model trainer 186) but only temporarily or for a specific purpose, and by keeping the high-dimensional data to retain the ability to explain a result in a different context.

In some embodiments, the machine learning model trainer 186 generates a trained fraud model, which may refer to new ad-hoc models specifically tailored to the enhanced training dataset and the labeled fraud. The training response generated by the machine learning model may be a potential fraud indicator, such as a probability of confidence that the input augmented training data is associated with fraudulent activity, or a list of features indicative of frauds, or an indication on the nature or the time period of the fraud, or a list of due diligence questions that an investor should ask from the portfolio manager to assuage his concerns.

At block 310, the machine learning model trainer 186 analyzes the training response based on the input provided to the machine learning model. The machine learning model trainer 186 may perform an automated analysis of the training response, for example by reserving a portion of the known fraudulent activity as a test dataset and comparing the training response to the indicator of known fraudulent activity to determine a success rate of the machine learning model in accurately assessing a potential for fraudulent activity in the training data. In some embodiments, at least a portion of the training responses generated by the machine learning model may be provided to a post-analysis review system 170. The post-analysis review system 170 may use an automated or human-driven review process to assess the accuracy of the machine learning model based on the training response.

At block 312, the machine learning model trainer 186 modifies the machine learning model based on the analysis of the training response. In some embodiments, modifying the machine learning model may refer to modifying a weight value of a machine learning model. Modifying the weight value may result in a change in the functionality of the machine learning model. Successive modifications of weight values of the machine learning model may result in a trained machine learning model capable of more accurately assessing the potential for fraudulent activity in input data. In some embodiments, modifying the machine learning model may refer to modifying a parameter value of a machine learning model. In some embodiments, modifying a machine learning model may refer to modifying a weight associated with an output of one or more machine learning models in a multi-model configuration. In some embodiments, modifying a machine learning model may refer to modifying a layer size, allocated computing resources (e.g., memory), quantizing a model, or otherwise altering the model based on the analysis of the training response. Analysis of the training response may include, for example, comparing the training response to an expected response, comparing the training response to output from a second machine learning model, applying the training response as input to a machine learning model trained to determine an accuracy of the training output, human review, or any method of determining whether or how to modify the machine learning model based on the training response.

At block 314, the machine learning model trainer 186 stores the trained machine learning model for later use. The machine learning model trainer 186 may store the trained machine learning model at a storage location of the fraud indicator identification system 180. In some embodiments, the machine learning model trainer 186 may store the trained machine learning model at a storage location of the machine learning model provider 120, or another storage location provided by a third party. In some embodiments, the machine learning model trainer 186 may store weight values of the trained machine learning model such that the weight values can be applied to the machine learning model at a future time while reducing the overall amount of storage capacity required to store the model. When the machine learning model trainer 186 has stored the trained model, the routine 300 moves to block 316 and ends.

### Identifying Fraud Risk and Report Creation

FIG. 4 illustrates example routine 400 for identifying fraud risk indicators in a specific fund. The routine 400 begins at block 402, for example in response to the fraud indicator identification system 180 receiving a request (e.g., from a user device 110) to analyze data to determine whether there are indicators of potential fraud. In some embodiments, the routine 400 may begin automatically, for example in response to updated data related to one or more entities being received. In some embodiments, the routine 400 may operate continuously at regular or irregular intervals by accessing data to determine whether additional data is available for analysis and then proceeding.

At block 404, the data aggregator 182 accesses data that will be analyzed to identify indicators of potential fraud. The data aggregator 182 may access data as described previously herein with respect to block 204 of the routine 200.

At block 406, the data aggregator 182 aggregates the accessed data. The data aggregator 182 may aggregate the accessed data as described previously herein with respect to the routine 200.

At block 408, the machine learning model executor 188 applies the aggregated data as input to a machine learning model to cause the machine learning model to generate fraud indicator information and a fraud probability score. The machine learning model may be a model trained to identify indicators of potential fraud and to generate a fraud probability score as described with respect to routine 300 previously herein. The machine learning model executor 188 may access the machine learning model from the machine learning model provider 120. In some embodiments, the machine learning model executor 188 may execute the machine learning model at the machine learning model provider 120 by providing weight values for the model, or by providing the aggregated data to be input to the machine learning model. Applying the aggregated data as input to the machine learning model causes the machine learning model to generate an output. The output of the machine learning model includes a fraud probability score, descriptive information on the fraud(s) like its likely nature or its period or key reasons for the suspicions and any fraud indicator information where the machine learning model use to determine that there is potential fraudulent activity indicated in the aggregated data. Advantageously, fraud indicator information may assist in ensuring that the fraud probability score is explainable, thereby minimizing the potential risk in a model hallucination or other issue causing an incorrect fraud probability score. Explainability also permits users subject to fiduciary obligation to properly understand the operational risk associated with the fund and act according to their own sets of constraints (such as request further diligence, request a change in strategy or disengage from the fund). Further, the fraud indicator information may assist in the verification of the generated fraud probability score by the post-analysis review system 170.

Fraud indicator information may include various types of information. In some embodiments, the fraud indicator information may include an indication of data in the aggregated data that may be associated with fraudulent activity. In some embodiments, fraud indicator information may include reasoning generated by the machine learning model describing a reasoning associated with the determination of the fraud probability score by the machine learning model. A reasoning may indicate information provided to the machine learning model based on which the machine learning model has determined the fraud probability score. A reasoning generated by the machine learning model may be in natural language. The reasoning may include a description associated with a type of fraud. A reasoning may provide information indicating how a recipient of the reasoning may proceed to further investigate potential fraudulent activity. For example, the reasoning may indicate that a user is recommended to contact a fund manager and ask a question, generated or accessed by the machine learning model, to obtain additional information related to a fund's activity. The information received from the fund manager may be provided to the machine learning model in a second operation of the machine learning model along with information associated with the fund to redetermine the fraud probability score based on the response.

At decision block 410, the fraud indicator identification system 180 determines whether the fraud probability score or various scores over a given period exceeds a threshold value. The threshold may be a fixed value. In some embodiments, the threshold may be a dynamic value. A dynamic threshold may be based on one or more threshold factors. A threshold factor may include, for example, a risk tolerance (e.g., associated with an individual or an organization), a history of known fraudulent activity (e.g., associated with an entity, an individual fund, a fund manager, etc.), an absolute return rate for a fund, a relative return rate of a fund relative to similar funds (e.g., based on value, entity size, etc.), a value of assets under management, or any other information accessible to the fraud indicator identification system 180. Where the fraud probability score satisfies the threshold value and if the user requires the need for a detailed explanation, the routine 400 moves to block 412.

Otherwise, where the fraud probability score fails to satisfy the threshold value, the routine 400 may move to block 418 and end. In some embodiments, in place of a threshold or in addition to a threshold, the fraud indicator identification system 180 may receive a request from a user (e.g., associated with the user device 110) or a system to proceed with providing fraud prediction information or a fraud report. The result may be fraud prediction information or a fraud report indicating a reasoning of one or more machine learning models of the fraud indicator identification system 180 for determining the fraud probability score.

At block 412, the fraud indicator identification system 180 provides fraud prediction information and aggregated fund data to a post-analysis review system 170 for further analysis or investigation. The fraud prediction information may include the fraud probability score. The fraud prediction information may include a rationale generated by the machine learning model used to generate a fraud probability score. In some embodiments, the fraud indicator identification system 180 may provide all aggregated fund data associated with the fund to the post-analysis review system 170. In some embodiments, the fraud indicator identification system 180 may provide a portion of the aggregated fund data to the post-analysis review system 170. For example, the fraud indicator identification system 180 may identify aggregated fund data associated with the fraud probability score determination (e.g., as described in the reasoning generated by the machine learning model). The fraud indicator identification system 180 may provide the identified aggregated fund data to the post-analysis review system 170 for further analysis.

At block 414, the report generator 189 generates a fraud report. The fraud report may be formatted according to a specified format. For example, the report generator 189 may analyze a given fraud from a collection of various legal documents, laws, and the jurisprudential framework, which highlights specific information, which are then fed into the post-analysis review system 170, the training data generator 184 or the machine learning model trainer 186. For example, the fraud report may include different sections about the nature or timing of the fraud, or which set of data contributed to the analysis. In some embodiments, the report may be written in a language that fits the user's technical competence, since a young High Net Worth Individual may need a high-level summary of the fraudulence, while the CIO of an institutional pension fund or a Fund-of-Hedge-Fund may require all the technical details on the analysis. For example, the fraud report may be formatted according to a format provided by a user that will receive the fraud report. In another example, the fraud report may be formatted according to a standardized reporting format (e.g., a format used by an enforcement agency, a financial institution, etc.). The fraud report may include information generated by the fraud indicator identification system 180. For example, the fraud report may include the fraud probability score, at least a portion of the rationale, aggregated fund data, or information used by the fraud indicator identification system 180 to determine the fraud probability score.

At block 416, the report generator 189 provides the fraud report. The report generator 189 may provide the fraud report to a user device 110 to be presented to a user. The report generator 189 may provide the fraud report by transmitting the fraud report to a storage location for later access or use via the network 150. The user may have to demonstrate his identity or his competence in hedge funds, or may have to abide to legal terms, or may have to pay for the services. The user may elicit receiving online access to the graphs and tables included in the report, rather than a fully written report. When the report generator 189 has provided the fraud report, the routine 400 moves to block 418 and ends.

### Execution Environment

FIG. 5 illustrates various components of an example computing device 500 configured to implement various functionality described herein.

In some embodiments, the computing device 500 may be implemented using any of a variety of computing devices, such as server computing devices, desktop computing devices, personal computing devices, mobile computing devices, mainframe computing devices, midrange computing devices, host computing devices, or some combination thereof.

In some embodiments, the features and services provided by the computing device 500 may be implemented as web services consumable via one or more communication networks. In further embodiments, the computing device 500 is provided by one or more virtual machines implemented in a hosted computing environment. The hosted computing environment may include one or more rapidly provisioned and released computing resources, such as computing devices, networking devices, and/or storage devices. A hosted computing environment may also be referred to as a “cloud” computing environment

In some embodiments, as shown, a computing device 500 may include: one or more computer processors 502, such as physical central processing units (“CPUs”); one or more network interfaces 504, such as a network interface cards (“NICs”); one or more computer readable medium drives 506, such as a high density disk (“HDDs”), solid state drives (“SSDs”), flash drives, and/or other persistent non-transitory computer readable media; one or more input/output device interfaces 508; and one or more computer-readable memories 510, such as random access memory (“RAM”) and/or other volatile non-transitory computer readable media.

The computer-readable memory 510 may include computer program instructions that one or more computer processors 502 execute and/or data that the one or more computer processors 502 use in order to implement one or more embodiments. For example, the computer-readable memory 510 can store an operating system 512 to provide general administration of the computing device 500. As another example, the computer readable memory 510 can store machine learning model trainer 514 for training a machine learning model (e.g., as described with respect to routine 300 above herein). As another example, the computer-readable memory 510 can store a machine learning model executor 516 to execute a machine learning model (e.g., to generate a predicted likelihood of fraudulent activity, or a report, as described with respect to routine 400 above herein).

### Terminology

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions, or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware, or as software that runs on hardware, depends upon the particular application and design conditions imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A method of training machine learning models comprising:
accessing a set of training data comprising a subset of positively labeled data items and a subset of negatively labeled data items;
augmenting the set of training data, wherein augmenting the set of training data comprises:
identifying a positively labeled data item of the subset of positively labeled data items;
generating, based on the positively labeled data item, at least two new positively labeled data items, wherein each of the at least two new positively labeled data items is distinct from the subset of positively labeled data items; and
combining the at least two positively labeled data items with the set of training data to generate augmented training data;
applying the augmented training data as input to a machine learning model to cause the machine learning model to generate a training response;
analyzing the training response to generate an analysis result;
modifying a value of the machine learning model based on the analysis result to generate a trained machine learning model; and
storing the trained machine learning model.

2. The method of claim 1, wherein generating, based on the positively labeled data item, a new positively labeled data item comprises:
determining a timeframe associated with the positively labeled data item; and
dividing the positively labeled data into a plurality of new positively labeled data items, wherein each new positively labeled data item of the plurality of new positively labeled data items is associated with a portion of the timeframe, and wherein the at least two new positively labeled data items are of the plurality of new positively labeled data items.

3. The method of claim 2, wherein the portion of the timeframe associated with each new positively labeled data item of the plurality of new positively labeled data items is non-overlapping.

4. The method of claim 1, wherein the at least two new positively labeled data items replace the positively labeled data item in the set of training data.

5. The method of claim 1, further comprising:
accessing first data from a first data source;
accessing second data from a second data source;
determining an association between the first data and the second data; and
based on the association between the first data and the second data, generating the positively labeled data item.

6. The method of claim 5, wherein determining the association between the first data and the second data comprises:
identifying a first entity identifier from the first data;
identifying a second entity identifier from the second data;
determining the first entity identifier is associated with the second entity identifier; and
generating a link between the first data and the second data based on the first entity identifier being associated with the second entity identifier.

7. The method of claim 6, wherein the first entity identifier is different from the second entity identifier.

8. The method of claim 1 further comprising:
accessing additional data;
applying a first data item of the additional data as input to the trained machine learning model to cause the model to generate an output; and
determining, based on the output, the first data item is associated with potential fraudulent activity.

9. The method of claim 8, wherein the output comprises a probability score associated with the first data item, and wherein determining the first data item is associated with fraudulent activity is based on the probability score exceeding a threshold value.

10. The method of claim 8, wherein the output comprises a description of fraud indicators associated with the first data item.

11. The method of claim 1, wherein augmenting the set of training data further comprises:
accessing a set of known fund investment strategies;
identifying a negatively labeled data item of the subset of negatively labeled data items;
comparing at least one of the negatively labeled data item or a data item associated with the negatively labeled data item to the set of known fund investment strategies to generate a comparison result, wherein the comparison result indicates an anomaly is present in the negatively labeled data item;
based on the comparison result, relabeling the negatively labeled data item to generate an additional positively labeled data item.

12. The method of claim 1 further comprising:
accessing first data from a first data source;
accessing second data from a second data source;
identifying a first entity identifier from the first data, wherein the first entity identifier is associated with a portion of the first data;
identifying a second entity identifier from the second data, wherein the second entity identifier is associated with a portion of the second data, and wherein the second entity identifier is different from the first entity identifier;
determining a first data item in the first data and a second data item in the second data is the same;
based on the first data item and the second data item being the same, determining the first entity identifier and the second entity identifier are associated with a same entity;
generating a link between the first entity identifier, the second entity identifier, and the same entity;
based on the link, aggregating the portion of the first data and the portion of the second data to generate aggregated data;
storing the aggregated data;
applying the aggregated data as input to the trained machine learning model to cause the trained machine learning model to generate an output comprising a fraud probability score;
determining, based on the fraud probability score, that at least one data item of the aggregated data is associated with potential fraud; and
generating a report comprising an indication of the at least one data item.

13. The method of claim 12 further comprising transmitting the report to a post-analysis review system.

14. The method of claim 12, wherein the report further comprises a description indicating a reason the at least one data item is associated with potential fraud.

15. The method of claim 14, wherein the reason is generated by the trained machine learning model, and wherein the output comprises the reason.

16. A non-transitory, computer-readable medium encoded with computer-executable instructions executable by a processor of a computing device, wherein the computer-executable instructions, when executed by the processor, cause the computing device to:
access a set of training data comprising a subset of positively labeled data items and a subset of negatively labeled data items;
augment the set of training data, wherein augmenting the set of training data comprises:
identify a positively labeled data item of the subset of positively labeled data items;
generate, based on the positively labeled data item, at least two new positively labeled data items, wherein each of the at least two new positively labeled data items is distinct from the subset of positively labeled data items; and
combine at least one of the at least two positively labeled data items with the set of training data to generate augmented training data;
apply the augmented training data as input to a machine learning model to cause the machine learning model to generate a training response;
analyzing the training response to generate an analysis result;
modify a value of the machine learning model based on the analysis result to generate a trained machine learning model; and
store the trained machine learning model.

17. The non-transitory, computer-readable medium of claim 16, wherein the computer-executable instructions, when executed by the processor, further cause the computing device to:
access additional data;
apply a first data item of the additional data as input to the trained machine learning model to cause the model to generate an output; and
determine, based on the output, the first data item is associated with potential fraudulent activity.

18. The non-transitory, computer-readable medium of claim 16, wherein the computer-executable instructions, when executed by the processor, further cause the computing device to:
replace the positively labeled data item in the set of training data with the at least two new positively labeled data items.

19. The non-transitory, computer-readable medium of claim 16
access first data from a first data source;
access second data from a second data source;
determine an association between the first data and the second data; and
based on the association between the first data and the second data, generate the positively labeled data item.

20. A system comprising:
a non-transitory computer-readable memory storing computer-executable instructions; and
one or more processors in communication with the memory, wherein the computer-executable instructions, when executed by the one or more processors, causes the one or more processors to at least:
access a set of training data comprising a subset of positively labeled data items and a subset of negatively labeled data items;
augment the set of training data, wherein augmenting the set of training data comprises:
identify a positively labeled data item of the subset of positively labeled data items;
generate, based on the positively labeled data item, at least two new augmented data items, wherein each of the at least two new augmented data items is distinct from the subset of positively labeled data items; and
combine the at least two augmented data items with the set of training data to generate augmented training data;
apply the augmented training data as input to a machine learning model to cause the machine learning model to generate a training response;
analyzing the training response to generate an analysis result;
modify a value associated with the machine learning model based on the analysis result to generate a trained machine learning model; and
store the trained machine learning model.
